(19) United States
(12) Patent Application Publication
(10) Pub. No.: US 2023/0128698 A1
(43) Pub. Date: Apr. 27, 2023

(54) ENERGY RECOVERY ASSEMBLY, FUEL CELL SYSTEM AND VEHICLE WITH ENERGY RECOVERY ASSEMBLY

(71) Applicants: Airbus Operations GmbH, HAMBURG (DE); Airbus Defence and Space GmbH, TAUFKIRCHEN (DE)

(72) Inventors: Uwe WOLLRAB, HAMBURG (DE); Barnaby LAW, HAMBURG (DE); Winfried LOHMILLER, TAUFKIRCHEN (DE); Jürgen STEINWANDEL, UHLDINGEN-MUEHLDORF (DE); Dankwart EIERMANN, WEISSENBERG (DE)

(21) Appl. No.: 17/911,845

(22) PCT Filed: Feb. 25, 2021
(86) PCT No.: PCT/EP2021/054649

§ 371 Date: Sep. 15, 2022

(30) Foreign Application Priority Data
Mar. 19, 2020 (DE) 102020107590.1

(51) Int. Cl. H01M 8/0656; H01M 8/04119; H01M 8/04111; C25B 1/04; H01M 8/04082

(52) U.S. Cl. CPC H01M 8/0656; H01M 8/04156; H01M 8/04111; C25B 1/04; H01M 8/04201; H01M 2250/20

(57) ABSTRACT

An energy recovery assembly, fuel cell system and vehicle, with an electrolyzer configured to provide a fuel and an oxidant, a fuel cell configured to convert the fuel and an oxidant to electrical energy, a tank configured to store the fuel or the oxidant, and a conduction pathway connecting the tank to the electrolyzer and the fuel cell. The assembly also includes: an expansion machine disposed in the conduction pathway and configured to expand a fluid flowing through the expansion machine and to obtain mechanical energy; and a valve arrangement configured to put the pathway in a first mode in which the fuel or the oxidant is guided to the tank, or in a second mode in which the fuel cell or the oxidant is guided to the fuel cell, wherein the fuel or the oxidant in the first and second modes flows through the expansion machine.

### RELATED APPLICATIONS

This application is a National Stage of International Application No. PCT/EP2021/054649, filed on Feb. 25, 2021, which claims priority to German Patent Application No. 10 2020 107 590.1, filed on Mar. 19, 2020, the entireties of all of which are incorporated herein by reference.

### FIELD OF THE INVENTION

The invention relates to an energy recovery assembly, to a fuel cell system having such an assembly and to a vehicle having such an assembly. More particularly, the invention relates to an energy recovery assembly having an expansion machine and a valve arrangement that guides a fluid through the expansion machine.

In conventional fuel cell systems, fuel and/or an oxidant is stored in a pressure vessel and supplied from there to the fuel cell for generation of electrical energy. The fuel cell and/or the oxidant has a higher pressure in the pressure vessel than is required for the operation of the fuel cell. The cooling energy obtained in the expansion (reduction in pressure) of the fuel and/or oxidant that is typically conducted is usually used for cooling of the fuel cell or for separation of water out of the fuel cell off gases.

It is an object of the invention to provide an apparatus that improves the operation of a fuel cell system and makes it more efficient.

### SUMMARY OF THE INVENTION

This object may be achieved by an energy recovery assembly having the features of the various embodiments described herein, by a fuel cell system having the features of the various embodiments described herein, and by a vehicle having the features of the various embodiments described herein.

In a first aspect, for better understanding of the present disclosure, an energy recovery assembly comprises an electrolyzer set up to provide a fuel and an oxidant, a fuel cell set up to convert the fuel and an oxidant to electrical energy, a tank set up to store the fuel or the oxidant, and a conduction pathway that connects the tank to the electrolyzer and the fuel cell. The electrolyzer, with the aid of electrical current, is able to split a compound composed of fuel with oxidant and to separate it into fuel and oxidant. The electrolyzer can also merely provide the fuel, while the oxidant is released to the environment. The fuel cell can likewise also receive the oxidant from the environment (for example ambient air). If both fuel and oxidant are stored and do not come from the environment, the energy recovery assembly may also comprise a further tank, such that the fuel is stored in a first tank and the oxidant in a second tank. The conduction pathway may comprise any number of conduits and valves and/or shutoff devices in order to connect the tank to the electrolyzer and to the fuel cell. It is of course also possible to connect the electrolyzer to the fuel cell via the conduction pathway.

The energy recovery assembly may also comprise an expansion machine disposed in the conduction pathway, which is set up to expand a fluid (gas and/or liquid) flowing through the expansion machine and to obtain mechanical energy. The expansion machine thus converts the energy released in the expansion of the fluid to mechanical energy. The mechanical energy may take the form of a rotational movement or a repeating linear movement.

In addition, the energy recovery assembly may comprise a valve arrangement set up to put the conduction pathway in a first conduction mode in which the fuel or the oxidant is guided to the tank, or in a second conduction mode in which the fuel cell or the oxidant is guided to the fuel cell. This can especially be effected by opening and closing at least one valve in the conduction pathway, such that the fuel or the oxidant is guided through appropriate conduits (conduit sections) of the conduction pathway to the tank or to the fuel cell.

The fuel or the oxidant flow through the expansion machine both in the first conduction mode and in the second conduction mode. As a result, for example, the expansion machine can obtain mechanical energy irrespective of whether the fuel cell is in operation or not. For instance, in the first conduction mode, the electrolyzer can generate fuel and/or oxidant, which are run through the expansion machine and then conducted to the tank. In the second conduction mode, fuel or oxidant stored in the tank can be supplied to the fuel cell for operation thereof through the expansion machine. In both cases, a pressure differential can be exploited in order to operate the expansion machine. In the first conduction mode, the pressure differential results from the pressure of the fuel and/or oxidant in the electrolyzer (which is usually operated under pressure) and the pressure currently existing in the tank (which is usually lower when the tank is being filled and rises only gradually). In the second conduction mode, the pressure differential results from the pressure in the (filled) tank and the operating pressure of the fuel cell, when a sufficient amount of fuel or oxidant is stored, a pressure that exists in the tank will usually be greater than the operating pressure of the fuel cell.

By virtue of the possible gain in mechanical energy in both modes by virtue of the expansion machine, the entire fuel cell system is improved, since the mechanical energy can be utilized additionally. Particularly during the operation of the fuel cell, in conventional systems, the energy released by the expansion of the fuel or the oxidant is not used at all, or used only to a small degree (for example for cooling). Any pressure differential between electrolyzer and tank is not exploited at all in conventional systems.

In one configuration variant, the energy recovery assembly may also comprise a further expansion machine, such that a first expansion machine is provided for the fuel and a second expansion machine for the oxidant. Correspondingly, the energy recovery assembly also comprises a further tank for storage, for example, of the oxidant when the fuel is being stored in the first tank.

It is possible here for the two expansion machines to be fluidically divided from one another, such that there is no mixing of the fuel and the oxidant. However, the mechanical energy of the two expansion machines may be consolidated. For example, the two expansion machines may be mechanically coupled to one another via a common shaft, a common axle and/or a common transmission.

In another configuration variant, the valve arrangement may comprise a multiway valve set up to connect a tank conduit of the tank either to an outlet conduit of the expansion machine or to a feed to the expansion machine. In this way, the multiway valve can be used to switch back and forth between the first and second conduction mode. In addition, it is also the case that only a single tank conduit is needed for the tank, so as to reduce weight, complexity and size of the energy recovery assembly.

In a further configuration variant, the valve arrangement may comprise a shutoff valve which is disposed in an outlet conduit of the electrolyzer and can adjust a flow cross section of the outlet conduit, and/or a shutoff valve which is disposed in a feed to the fuel cell and can adjust a flow cross section of the feed. The shutoff valves may, for example, completely close the flow cross section of the outlet conduit or feed. The shutoff valve in the outlet conduit of the electrolyzer can prevent conduction of fuel or oxidant to the electrolyzer in the second conduction mode. By virtue of the shutoff valve in the feed to the fuel cell, it is correspondingly possible to avoid conduction of fuel or oxidant to the fuel cell in the first conduction mode.

Alternatively or additionally, the valve arrangement may comprise a multiway valve set up to connect a feed of the expansion machine either to an outlet conduit of the electrolyzer or to a tank conduit of the tank. This multiway valve may be used, for example, as a replacement for the multiway valve between tank conduit, outlet conduit and feed to the expansion machine, and for the shutoff valve in the outlet conduit of the electrolyzer. This can save weight.

Likewise alternatively or additionally, the valve arrangement may comprise a further multiway valve set up to connect an outlet conduit of the expansion machine either to a feed to the fuel cell or to a tank conduit of the tank. Here too, the further multiway valve may be used, for example, as a replacement for the shutoff valve in the feed to the fuel cell.

In one configuration variant, the expansion machine may be a rotary flow machine. For example, the expansion machine may be implemented as a rotary piston expansion machine. A rotary piston expansion machine is especially suitable for use in a fuel cell/electrolyzer system since it can work at high pressures and low volume flow rates, as typically exist in such systems. In an alternative configuration, the expansion machine may be implemented as a turbo machine (turbine). In order to be able to decompress the fuel or the oxidant even in the case of relatively large pressure differentials, a turbo machine may also be in a multistage configuration, but this leads to a greater weight compared to the rotary piston expansion machine.

In a further configuration variant, the rotary flow machine may comprise a tooth arrangement. For example, the tooth arrangement may comprise more than two teeth, preference being given to using a tooth arrangement having five to ten teeth and particular preference to one having seven teeth.

In yet a further configuration variant, the tooth arrangement may comprise a first section and a second section, wherein the first section is disposed in a rotatable manner on a fixed conduit arrangement of the expansion machine and the second section is disposed in a rotatable manner about the first section. In addition, an expansion space of the expansion machine may be provided between the first section and the second section. This construction enables a fixed conduit arrangement, wherein the moving parts that absorb the mechanical energy obtained in the form of a rotational movement may be disposed on the outside without affecting the conduit arrangement. This enables a compact construction of the expansion machine.

In another configuration variant, the expansion machine may comprise a transmission output set up to output the mechanical energy obtained in the form of rotary movement. The transmission output may be implemented in the form of an axle, a shaft and/or a gear.

Alternatively or additionally, the expansion machine may be set up to convert the mechanical energy obtained to electrical energy and output it. For example, the expansion machine may comprise a generator (or at least parts thereof), such that the mechanical energy is converted directly to electrical energy in the expansion machine.

Likewise alternatively or additionally, the energy recovery assembly may also comprise a generator or motor coupled to the expansion machine. The generator is designed to generate electrical power from the mechanical energy output by the expansion machine, while the motor is already designed as a consumer of electrical energy generated by the expansion machine (or the generator).

In another configuration variant, the electrolyzer may finally be operated under a pressure between 15 and 200 bar. Preferred operation of the electrolyzer is envisaged as a pressure between 50 and 150 bar, and particular preferred operation at a pressure of 100 bar +/−5 bar. The higher the pressure in the electrolyzer, the greater the pressure differential relative to the tank (at least as long as the tank is not completely filled). The operating pressure of the electrolyzer thus corresponds to the maximum possible fill pressure of the tank. On the other hand, an operating pressure of the fuel cell may be between 2 and 15 bar, preferably between 5 and 10 bar and more preferably about 7 bar. This also results in a corresponding pressure differential between filled tank and fuel cell, which can be utilized in the expansion machine. It is of course also possible for the pressure in the tank to be higher, for example when the output fluid from the electrolyzer is compressed additionally or the tank is filled from another source with higher pressure. For instance, the fill pressure of the tank may even be up to 700 bar.

In yet a further configuration variant, the energy recovery assembly may comprise a conveying device set up to convey a starting medium for the electrolyzer and to feed it to the electrolyzer. In particular, the conveying device may take the form of a pump or compressor that conveys the starting medium into the electrolyzer. It is the conveying direction here that generates the operating pressure in the electrolyzer. By virtue of continuous conveying of the starting medium, the fuel generated in the electrolyzer and the oxidant are at a pressure corresponding to operating pressure at the electrolyzer exit.

It is thus possible, with the aid of the conveying device, also to control the pressure differential between the electrolyzer exit and the tank for the fuel or oxidant. For example, with increasing fill level of the tank, it is possible to increase the pressure in the electrolyzer by means of the conveying device, in order, for example, to keep the pressure differential constant at first. The pressure differential will of course fall as the fill level of the tank rises, until the pressure in the tank corresponds to the exit pressure of the electrolyzer and hence the tank is completely filled.

In a second aspect, for better understanding of the present disclosure, a regenerative fuel cell system comprises an energy recovery assembly according to the first aspect and a water tank set up to collect and to store water formed in the fuel cell. The water collected in the water tank may in turn be supplied to the electrolyzer in the energy recovery assembly, which, with the aid of electrical energy, splits the water into fuel (for example hydrogen) and oxidant (for example oxygen).

In a third aspect, for better understanding of the present disclosure, a vehicle comprises at least one energy recovery assembly according to the first aspect. Alternatively or additionally, the vehicle may comprise at least one renewable fuel cell system according to the second aspect.

The mechanical energy generated by the expansion machine may be used in the vehicle to drive any component. If the mechanical energy is being converted to electrical energy, the electrical energy may be consumed by any component in the vehicle. For example, the electrical energy may be fed into a bus in the vehicle via which at least one electrical load is supplied with electrical energy.

In a further aspect, the energy recovery assembly, in the first aspect, may also be used in an immobile article. For example, the energy recovery assembly may also be used in a built structure or in some other stationary form. For example, electricity obtained by solar energy and/or wind energy may be used to generate the fuel and for storage thereof in the tank, and the stored fuel in turn, in periods in which insufficient electrical energy, or none, is available via solar energy and/or wind energy, can be converted to electrical energy in the fuel cell. It is likewise also possible to use cheap power (when demand is low, for example power at night) to generate and to store fuel in order to be able to supply it back to the grid in periods in which the consumption of electrical energy reaches maximum loads (peaks).

In addition, the above-described aspects, configurations and variants may of course be combined, without explicit description thereof Any of the configuration variants described should thus be considered to be optional in respect of any of the aspects, configurations and variants or even combinations thereof The present disclosure is thus not restricted to individual configurations and configuration variants in the sequence described or a particular combination of the aspects and configuration variants.

### BRIEF DESCRIPTION OF THE DRAWINGS

Preferred working examples of the invention are elucidated in detail with reference to the schematic drawings appended, wherein:

FIG. 1 shows a schematic of an energy recovery assembly and reflects a first conduction mode;

FIG. 2 shows a schematic of an energy recovery assembly and reflects a second conduction mode;

FIG. 3 shows a schematic of a variant of a valve arrangement of an energy recovery assembly;

FIG. 4A shows a schematic of a longitudinal section of an expansion machine,

FIG. 4B shows a schematic of a cross section of an expansion machine; and

FIG. 5 shows a schematic of a vehicle with an energy recovery assembly.

### DETAILED DESCRIPTION OF EMBODIMENTS

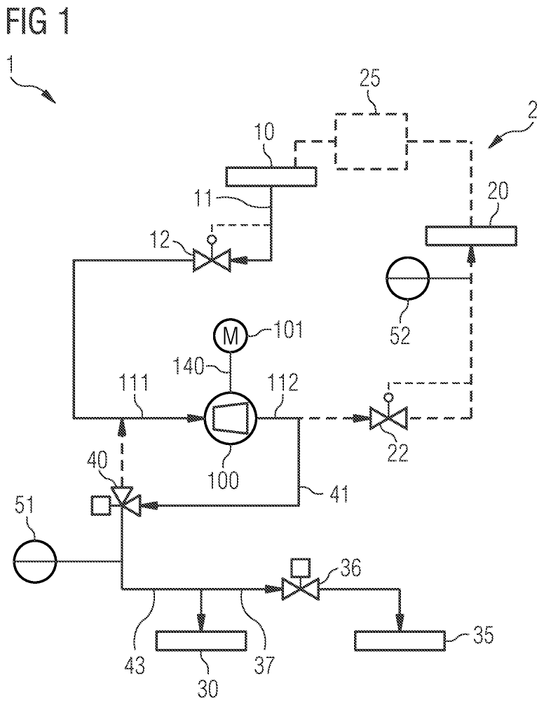

FIG. 1 shows a schematic of an energy recovery assembly 1. This comprises an electrolyzer 10 and a fuel cell 20, wherein the electrolyzer 10, by means of electrical energy, is able to generate and provide a fuel and an oxidant, while the fuel cell 20 can convert the fuel and an oxidant to electrical energy. The energy recovery assembly 1 further comprises a tank 30 in which fuel or oxidant can be stored, and a conduction pathway provided between tank 30, electrolyzer 10 and fuel cell 20. The conduction pathway can fluidically couple and/or connect the tank 30, electrolyzer 10 and fuel cell 20 to one another.

Part of the conduction pathway may be an outlet conduit 11 provided at an outlet of the electrolyzer 10, which leads off the fuel or oxidant generated in the electrolyzer 10. The electrolyzer 10 may of course comprise a second outlet (not shown separately), at which the other electrolysis product (oxidant or fuel) can flow out and be led off

A shutoff valve 12 may be provided for adjustment of a flow cross section of the outlet conduit 11. The shutoff valve 12 can completely close or completely open the flow cross section of the outlet conduit 11, or set it in any intermediate position. In this way, it is possible to control the pressure in the outlet conduit 11 of the electrolyzer 10 and hence (as far as and/or) at the outlet of the electrolyzer.

The energy recovery assembly 1 may also comprise an expansion machine 100. The outlet conduit 11 from the electrolyzer 10 may be fluidically coupled here to a feed 111 to the expansion machine 100. As shown in FIG. 1, fuel or oxidant is conducted from the electrolyzer 10 via the outlet conduit 11 (with the shutoff valve 12 open) and the conduit 111 into the expansion machine 100. The fuel or the oxidant, after leaving the expansion machine 100, is conducted onward via an outlet conduit 112 of the expansion machine 100 into a tank conduit 43 of the tank 30. The fuel or the oxidant can subsequently be stored in the tank 30.

On account of a pressure differential between the electrolyzer 10 and the tank 30, it is possible to expand the fuel or the oxidant in the expansion machine 100, meaning that the pressure of the fuel or the oxidant can be reduced, in which case the energy released is obtained in the form of mechanical energy by means of the expansion machine 100. Although the pressure differential decreases as the tank 30 is increasingly filled, the energy released can nevertheless be converted to mechanical energy in the course of expansion. The fuel or the oxidant may be in liquid form or gaseous form. It is likewise conceivable that the fuel or the oxidant is converted from the liquid state to the gaseous state in the expansion machine 100.

The expansion machine 100 may be coupled to a generator or motor 101. The generator 101 can convert the mechanical energy which is obtained in the expansion machine 100 to electrical energy. The coupling between expansion machine 100 and generator 101 may be via a transmission outlet 140. For example, the transmission outlet 140 may be a common shaft and/or a transmission (not shown separately). It is likewise conceivable that the expansion machine 100 has an integrated generator, such that electrical energy can be tapped directly from the expansion machine 100. This electrical energy can be used for the operation of the motor 101.

The energy recovery assembly 1 shown in FIG. 1 may also comprise a consumer 35 of the fuel or the oxidant, which is fluidically connected via an appropriate connection conduit 37 and shutoff valve 36 to the tank conduit 43. The consumer 35 may also be a further tank. It is likewise possible to design the valve 36 as a safety valve, such that any excess pressure in the conduction pathway can be released automatically. The consumer 35 in that case, rather than a tank, may also reflect the environment into which fluid is discharged from the conduction pathway for safety reasons.

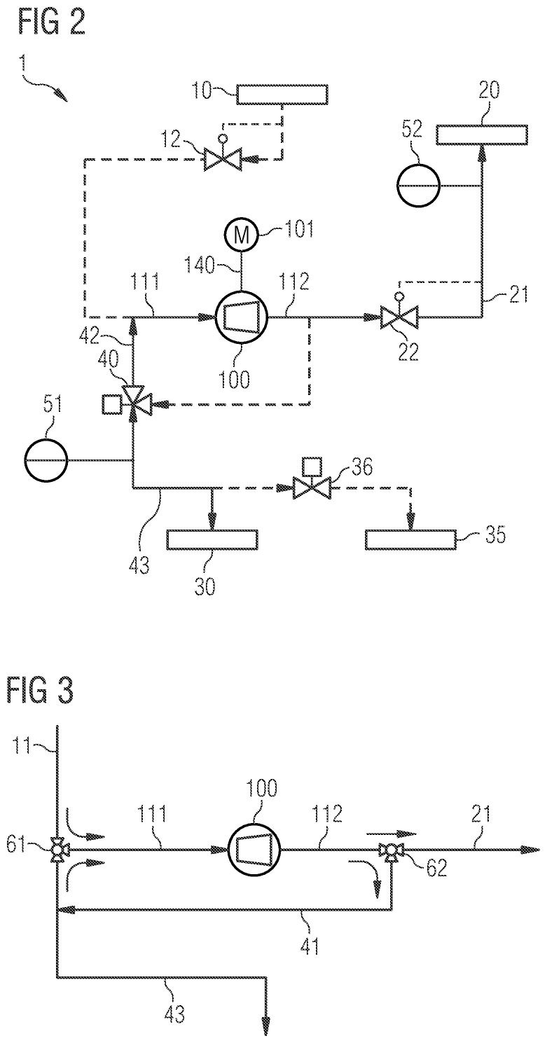

FIG. 2 shows a schematic of an energy recovery assembly 1 that reflects a second conduction mode. In the second conduction mode, the fuel or the oxidant can be conducted from the tank 30 to the fuel cell 20. FIGS. 1 and 2 show conduits through which the fuel or the oxidant can flow (i.e. are not closed by a (shutoff) valve) by solid lines, whereas dotted lines indicate closed, inactive conduits.

For example, shutoff valve 12 and shutoff valve 36 are closed in the second conduction mode according to FIG. 2. This allows the pressurized fluid (gas and/or liquid), the fuel or the oxidant here, to flow out of the tank 30 via the tank conduit 43 to the multiway valve 40. The multiway valve 40 then closes a section 41 of the tank conduit 43 connected to the outlet conduit 112 of the expansion machine 100. Instead, the multiway valve 40 establishes a fluidic connection between the tank conduit 43 and an intermediate conduit 42 which is fluidically connected to the feed 111 to the expansion machine 100. After flowing through the expansion machine 100 and the outlet conduit 112, the fuel or the oxidant is run through the shutoff valve 22, which is now open, into a feed 21 to the fuel cell 20. The section 41 of the tank conduit 43, as described, is closed by the multiway valve 40.

In this conduction mode too, there is a pressure differential between the tank 30 and the fuel cell 20. Therefore, the fuel or the oxidant does not just automatically flow to the fuel cell 20; instead, it is also possible to expand the fuel or the oxidant in the expansion machine 100 and to convert energy released to mechanical and/or electrical energy. The expansion machine 100 may be designed or may be adjustable in such a way that there is a pressure in the outlet conduit 112 that always corresponds to the operating pressure of the fuel cell 20, irrespective of the exit pressure that exists in the tank 30. Alternatively or additionally, the operating pressure of the fuel cell 20 may also be controlled/adjusted via the valve 22.

The other elements shown in FIG. 2 correspond to those that have already been elucidated with regard to FIG. 1. Therefore, these components are not described again.

FIG. 3 shows a schematic of a variant of a valve arrangement of an energy recovery assembly 1. FIG. 3 shows merely a section of the energy recovery assembly 1, with the other portion of the energy recovery assembly 1 corresponding to the energy recovery assembly from FIG. 1 or 2. Rather than the shutoff valve 12 in the outlet conduit 11 of the electrolyzer 10 and the multiway valve 40, in the variant according to FIG. 3, a multiway valve 61 is provided directly between outlet conduit 11, feed 111 to the expansion machine 100 and tank conduit 43. In a first conduction mode, the multiway valve 61 connects the outlet conduit 11 to the feed 111, as shown by the upper arrow. In a second conduction mode, the multiway valve 61 connects the tank conduit 43 to the feed 111, as shown by the lower arrow.

In addition, in the valve arrangement according to FIG. 3, the shutoff valve 22 in the feed 21 to the fuel cell 20 is replaced by a further multiway valve 62. As likewise indicated by arrows, in a first conduction mode, the outlet conduit 112 from the expansion machine 100 is fluidically connected to a section 41 of the tank conduit 43 (lower arrow), and, in a second conduction mode, the outlet conduit 112 is fluidically connected to the feed 21 to the fuel cell 20 (upper arrow). Thus, in the first and second conduction modes, the conduction pathway generated by the corresponding valve settings is achieved in a corresponding manner to those from FIGS. 1 and 2.

Irrespective of the respective variants of the valve arrangement, the valves 12, 22, 40, 61, 62 may be implemented in a valve block or a valve unit. It is thus possible to shorten conduit lengths between the respective valves or to dispense with these conduits entirely. In a likewise very compact implementation, such a valve block or valve unit may also be connected to or integrated into the expansion machine 100 for construction purposes. Such an expansion machine 100 accordingly requires only three connections for connection of the outlet conduit 11 of the electrolyzer 10, the feed 21 to the fuel cell 20, and the tank conduit 43.

Merely by way of example, the energy recovery assembly 1 may be present in a regenerative fuel cell system 2 (see FIG. 1) which additionally comprises a water tank 25. The water tank 25 can collect and store water formed in the fuel cell 20. The fuel cell system 2 in fuel cell operation can therefore generate electrical energy from the fuel stored, for example, in tank 30. If another source of electrical energy is available, the electrolyzer 10 may be operated while the fuel cell 20 is switched off. Then the electrolyzer 10 can split the water stored in the water tank 25 at least into fuel by means of electrical energy. It is thus possible to convert excess electrical energy to fuel, which is stored in tank 30 until the other source of electrical energy is no longer available and the system is switched back to fuel cell operation. In each of the two modes of operation, however, it is possible to use the expansion machine 100, and hence very efficiently to continuously and additionally provide mechanical and/or electrical energy.

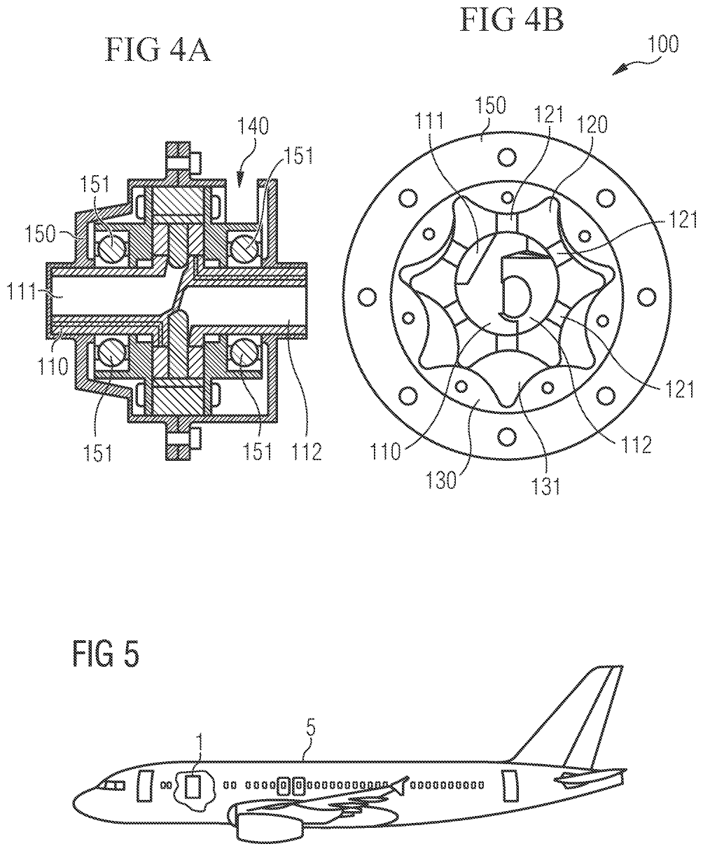

FIGS. 4A and 4B shows a schematic of a longitudinal section and a transverse section of an expansion machine 100. The expansion machine 100 shown in FIGS. 4A and 4B is a rotary piston expansion machine. It is of course also possible to use a different type of expansion machine 100 in the systems described here. The rotary piston expansion machine 100 may comprise, for example, a fixed conduit arrangement 110 containing the feed 111 on one side and the outlet conduit 112 from the expansion machine 100 on the other side.

The rotary piston expansion machine 100 may comprise a tooth arrangement. The tooth arrangement shown merely by way of example in FIGS. 4A and 4B comprises a first section 120 disposed in a rotatable manner on the fixed conduction arrangement 110, and a second section 130 disposed rotatably about the first section 120. For example, the first section 120 or the second section 130 may be disposed in a rotatable manner on the conduit arrangement 110 by means of bearings 151.

If fuel or oxidant then flows via the feed 111 to the first section 120 of the tooth arrangement, the fuel or the oxidant can pass through corresponding openings or apertures in the first section 120 into an expansion space 131. As a result of the expansion (reduction in pressure) of the fuel or oxidant, and by virtue of the different number of teeth in the first section and hollows or recesses in the second section 130, the first section 120 is pushed away from the second section 130. On account of the mounting of the first section 120 and of the second section 130 and owing to their mobility relative to one another, the first section 120 is rotated about the conduit arrangement 110, as a result of which the second section 130 is also rotated.

In this case, in another (roughly opposite) region of the expansion machine 100, the expansion space 131 is reduced in size as a result of convergence of the first and second sections 120, 130. Thus, the fuel or the oxidant is pushed through a corresponding opening or aperture in the first section 120 into the outlet conduit 112. Ultimately, the fuel or the oxidant is expanded, and the energy released is converted to the rotation of the first and second sections 120, 130, and hence mechanical energy.

The expansion machine 100 may comprise a housing 150. The housing 150 may be in fixed form, in which case the first and second sections 120, 130 rotate within the housing. Alternatively, the housing 150 may also be connected to the second section 130, such that the housing 150 rotates together with the second section 130.

A fixed housing 150 offers the option of using the relative movement between housing 150 and second section 130 for the formation of a generator. For instance, magnets (not shown), for example permanent magnets, may be disposed in the second section 130, in which case the housing 150 comprises coils (not shown) for generation of electrical current by the moving magnets.

Alternatively or additionally, the expansion machine 100 may also comprise a transmission outlet 140. This may exist merely by way of example in the form of an opening in the housing 150 and a gear disposed therein (not shown separately), which rotates together with the first section 120 or the second section 130.

FIG. 5 shows a schematic of a vehicle 5 with an energy recovery assembly 1. The vehicle 5 may, as shown in FIG. 5, be an aircraft that uses the energy recovery assembly 1 for generation of electrical power. It is likewise conceivable that the vehicle 5 may be a different mode of mass transport, for example a train, ship or bus, or even a car.

The vehicle 5 may also be a spaceship, satellite or pseudo-satellite (e.g. High Altitude Pseudo Satellite—HAPS). In this case, in particular, regenerative fuel cell systems 2 are advantageous since filling of a fuel cell system is not possible. Two different modes of operation are usually needed in the case of such space vehicles 5 as well. Firstly, solar cells (not shown) can convert sunlight to electrical energy. If, however, the solar cells are in the shade, the electrical energy has to be obtained by means of a different source (storage means), for example a fuel cell. It is thus possible, during the generation of electrical energy by means of the solar cells, to use a portion of the electrical energy in an electrolyzer 10 for generation of a fuel. While the solar cells are in the shade, the fuel thus generated can be converted to electrical energy in a fuel cell 20. With the energy recovery assembly 1 described here, it is possible in both modes of operation to generate additional mechanical energy and/or electrical energy by means of the expansion machine 100.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. An energy recovery assembly comprising:
an electrolyzes configured to provide a fuel and an oxidant;
a fuel cell configured to convert the fuel and the oxidant to electrical energy;
a tank configured to store the fuel or the oxidant;
a conduction pathway connecting the tank to the electrolyzer and the fuel cell,
an expansion machine disposed in the conduction pathway and configured to expand a fluid flowing through the expansion machine and to obtain mechanical energy; and
a valve arrangement configured to put the conduction pathway in a first conduction mode in which the fuel or the oxidant is guided to the tank, or in a second conduction mode in which the fuel cell or the oxidant is guided to the fuel cell,
wherein the fuel or the oxidant in the first conduction mode and the second conduction mode flows through the expansion machine.

2. The energy recovery assembly as claimed in claim 1, wherein the valve arrangement comprises a multiway valve configured to connect a tank conduit of the tank either to an outlet conduit of the expansion machine or to a feed to the expansion machine.

3. The energy recovery assembly as claimed in claim 1, wherein the valve arrangement comprises a shutoff valve disposed in an outlet conduit of the electrolyzer and configured to adjust a flow cross section of the outlet conduit or a shutoff valve disposed in a feed to the fuel cell and configured to adjust a flow cross section of the feed.

4. The energy recovery assembly as claimed in claim 1, wherein the valve arrangement comprises a multiway valve connecting a feed of the expansion machine either to an outlet conduit of the electrolyzer or to a tank conduit of the tank.

5. The energy recovery assembly as claimed in claim 4, wherein the valve arrangement comprises a further multiway valve set up to connect an outlet conduit of the expansion machine either to a feed to the fuel cell or to a tank conduit of the tank.

6. The energy recovery assembly as claimed in claim 1, wherein the expansion machine is a rotary flow machine.

7. The energy recovery assembly as claimed in claim 6, wherein the rotary flow machine comprises a tooth arrangement having preferably seven teeth.

8. The energy recovery assembly as claimed in claim 7, wherein the tooth arrangement comprises a first section and a second section, wherein the first section disposed rotatably on a fixed conduit arrangement of the expansion machine and the second section is disposed rotatably about the first section, and wherein an expansion space of the expansion machine is provided between the first section and the second section.

9. The energy recovery assembly as claimed in claim 1, wherein the expansion machine further comprises a transmission output configured to output the mechanical energy obtained as rotary movement, or
wherein the expansion machine is configured to convert the mechanical energy to electrical energy and output the electrical energy, or both.

10. The energy recovery assembly as claimed in claim 9, further comprising:
a generator or motor coupled to the expansion machine.

11. The energy recovery assembly as claimed in claim 9, wherein the electrolyzer is configured to be operated under a pressure between 15 and 200 bar.

12. A regenerative fuel cell system comprising:
the energy recovery assembly as claimed in claim 1; and
a water tank configured to collect and store water formed in the fuel cell.

13. A vehicle comprising: at least one energy recovery assembly as claimed in claim 1.

14. The energy recovery assembly as claimed in claim 6, wherein the expansion machine is a rotary piston expansion machine.

15. The energy recovery assembly as claimed in claim 7, wherein the rotary flow machine comprises seven teeth.
